(19) United States
(12) Patent Application Publication
(10) Pub. No.: US 2012/0151055 A1
(43) Pub. Date: Jun. 14, 2012

(54) Low Energy Mobile Information Delivery

(75) Inventors: Aman Kansal, Issaquah, WA (US); Jie Liu, Medina, WA (US); Dimitrios Lymperopoulos, Bellevue, WA (US)

(73) Assignee: Microsoft Corporation, Redmond, WA (US)

(21) Appl. No.: 12/965,862

(22) Filed: Dec. 11, 2010

(51) Int. Cl. G06F 15/173

(52) U.S. Cl. 709/225

(57) ABSTRACT

The subject disclosure is directed towards delivering information to mobile devices in an energy and bandwidth efficient manner by sending information only when the device user is likely to use the information. The information is delivered proactively based on user attention being paid to the device or the user's anticipated attention, corresponding to sensed state data and other state data. Also described is a proxy that interfaces with legacy information servers or the like, such as to emulate the mobile device, so that information delivery from such sources can be deferred until needed by the user. Device energy is conserved and user disruptions reduced by computing an inference as to when the user is likely to be interested in the communicated information, and downloading based upon the inference.

### BACKGROUND

Mobile device users use their devices with a wide variety of applications that deal with the delivery of information. For example, a contemporary mobile device allows a user's personalized information, including email, requested web content, advertisements, weather updates, digital books, music, and other media to be delivered over wireless and other communication channels. Some of this information is downloaded automatically by the mobile device (or applications running on the mobile device) expecting that the user will need it. The information may be downloaded periodically, or based on events, such as emails pushed when the server detects that new email has arrived for the user. Other information may be delivered based on the device's location (e.g., advertisements from local vendors), or based on user-specified rules and policies (e.g., download email every fifteen minutes during daytime, and every sixty minutes at night).

The delivery of this information consumes significant battery energy. For instance, a mobile phone, when not used to receive any digital information, may last seven to ten days on a typical 1000 mAh battery using contemporary technology, but only lasts one to two days when data delivery channels such as email and web browsing are enabled. Thus, when automatically downloaded content is not used by the user, it results in wasted energy and reduction of battery charge (and ultimately battery life).

Moreover, downloaded but unused content also may use up the user's data plan download limit and may result in data charges. Some messages such as SMS messages may be paid for on a per message basis, and some content may be paid for based on data size. Also, significant communication bandwidth is used up by the wireless network delivering this data to the mobile device, which is an expense to the carrier.

A simple strategy to save energy is to only receive and send content when manually requested by the user, but this is generally not very desirable for a number of reasons. For one, a user may not receive possibly important content, e.g., if a severe weather alert is generated at a weather information source, the user will miss the alert unless the user coincidentally happened to make the request at just the right time. Moreover, it takes some time to receive information, which may be inconvenient, frustrating and inefficient for the user. For instance, if the user requests that new email be downloaded, the user has to wait until the email downloads before being able to see the emails. Many users choose to automatically download emails to avoid this issue.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an inference is computed as to when the user is likely to be interested in accessing information that is available for downloading to a mobile device. If the user is not likely to be interested in accessing the information, then the download may be deferred until a later time, which tends to save device energy and/or reduce user disturbance. For example, a user may be driving, interacting with another device such as typing on a personal computer or playing a game, or not interacting with previously downloaded content such as email messages. In such instances, a download may be deferred until the user is likely to be interested, such as when he or she stops doing one current activity, and starts interacting with the device and/or previously downloaded content.

The inference may be computed based upon a current state of a user and/or the current state of a mobile device, possibly along with other state data. In general, the state data is used to determine an attention level corresponding to whether the user is currently interacting with the mobile device or is anticipated to be soon interacting with the mobile device, for example. The state data may be obtained from various device sensors/input devices of the mobile device, as well as other information such as which application the user is currently running. Other state data may be obtained from user-related sensors, including other devices the user may be using, motion detectors and cameras, biological and/or physiological sensors, and so forth. Still other state data such as time of day may be a factor in the attention level determination.

The attention level data may be matched against user preference data and/or historical data to make a decision (the inference) as to whether to download the information or defer downloading of the information. Other factors that may be used include the likely importance of the information itself, what entity is sending it, and so forth.

In one aspect, some or all of the information may be received at an intermediate proxy, which sends the information to the mobile device based upon the inference. The proxy may be configured as a virtual machine that emulates the mobile device from the perspective of the information source that is providing the information. The proxy may coalesce information from a plurality of sources to reduce the number of transmissions to the mobile device. The proxy also may compress and/or modify at least some of the information before sending it to the mobile device.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components configured to selectively deliver information to a mobile device based upon various factors (e.g., state data).

FIG. 2 is a flow diagram representing example steps for determining whether to deliver content to a mobile device or defer delivery.

FIG. 3 is a flow diagram representing example steps for evaluating rules and user activities for determining whether to deliver content to a mobile device.

FIG. 4 is a block diagram representing exemplary non-limiting networked environments in which various embodiments described herein can be implemented.

FIG. 5 is a block diagram representing an exemplary non-limiting computing system or operating environment in which one or more aspects of various embodiments described herein can be implemented.

### DETAILED DESCRIPTION

Various aspects of the technology described herein are generally directed towards delivering relevant information to mobile devices in an energy (and bandwidth) efficient manner. In general, based on the sensed state of the user and/or the device, and/or other data, information is sent to the mobile device only when the user is likely to use that information. Note that unlike prior mechanisms that deliver information based on explicit user requests, the technology described herein may deliver the information proactively such that it is available before the user needs it, and also when new information relevant to the user is generated, without the user's knowledge or request. As will be understood, not only is this technology advantageous with respect to saving energy, but the technology also provides the advantage of not disturbing the user when the user does not need information.

In one aspect, information sources may be configured to perform intelligent, controlled sending of information based upon current state data and other data, that is, to send information, not send information, or defer the sending of information. In another aspect, intermediate proxies can be used to provide the intelligent control of sending, not sending, or deferring of sending information when the information sources do not provide this capability. In general, the servers aware of intelligent, controlled sending technology and the intermediate proxy communicate with the mobile device based on a computed estimate of when the user is likely to be interested in obtaining the information.

It should be understood that any of the examples herein are non-limiting. For one, while the examples are directed to a user's mobile device, it is understood that the technology may be extended to any device that is interested in conserving energy, saving battery life, saving memory, and/or not disturbing a user (such as a portable device carried in a car). As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in mobile computing and information delivery in general.

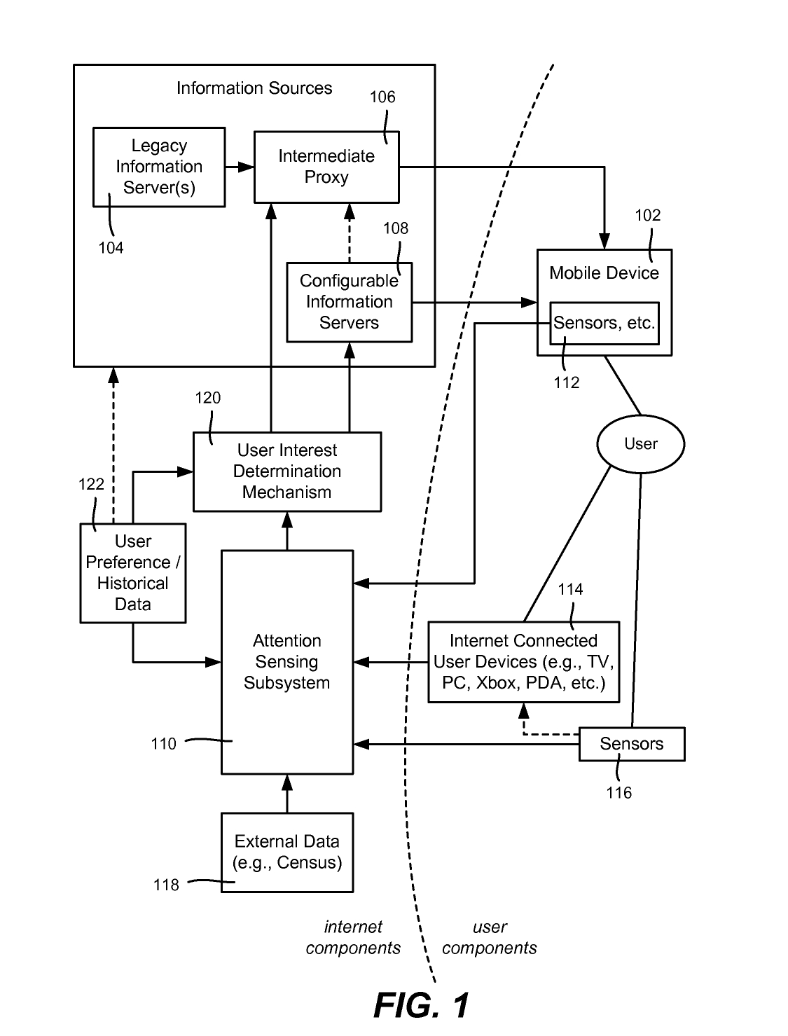

FIG. 1 shows example components of a system for delivering information to a mobile device 102 in a manner that saves energy and/or reduces disturbance of the user by delivering information only when it is likely to be useful. As will be understood, the technology provides automated information delivery, but reduces the amount of wasted information that is delivered, thereby conserving battery power, reducing data plan usage, and reducing the strain on network bandwidth, while at the same time reducing the amount of notifications (which may disturb a user) that occur when new information is delivered.

In one aspect, the information that is selected to be sent to the mobile device may further reduce the device energy usage by collecting (coalescing) multiple pieces of information into a single transmission. Note that for mobile devices, it is typically less efficient to receive multiple smaller communications compared to a single large transmission, generally because the electronics used for communication consume energy just to start up and shut down for each communication.

In FIG. 1, one or more legacy information servers 104 comprise generally existing sources of information from which the information to be sent to the mobile device is generated or received for forwarding. Examples of legacy information servers 104 include email servers, advertisement servers, weather data servers, or any other sources. In general, the legacy servers 104 are those that do not support/are not configurable to support the technology described herein, and continue to deliver information in the same way that they currently do.

To implement intelligent, controlled delivery as described herein, an intermediate proxy 106 (or possibly more than one) may be used, comprising a module or the like that collects information from the one or more legacy information servers 104 and determines when the information is to be sent to the mobile device 102. The intermediate proxy 106 may be implemented as a virtual machine that emulates the mobile device, e.g., exactly from perspective of the legacy information servers 104, thus enabling the legacy servers 104 to communicate using the same mechanisms currently used to communicate with the mobile device 102.

An alternative intermediate proxy 106 may be implemented as a network packet interception and response module, which allows the legacy servers 104 to communicate with the intermediate proxy 106; however the packets are processed differently that they are by the mobile device 102. Other alternative implementations of intermediate proxies are feasible. For example, a proxy or part of a proxy may be located on a user's personal computer, on a router, and/or on any device that couples to the user's network.

Other servers may be configured with an awareness of intelligent, controlled delivery, (or may be configured with settings that basically provide intelligent, controlled delivery), shown in FIG. 1 as configurable information servers 108. These configurable information servers 108 are additional sources of information, but have been configured to determine when information is to be sent to the mobile device as described herein.

In general, the proxy 106 and aware servers 108 determine how to handle information delivery based upon the user's perceived need for the information and/or the nature of the information. For example, information that is outdated if not sent right away need not be sent to a mobile device when the device user is not going to see the information for awhile; a stock ticker and weather updates are examples of such information that can be discarded without sending, as they can be replaced with more current information as soon as the user starts interacting with the device or just before the user is likely to start interacting with the device. Note that exceptions may be severe weather alerts (e.g., send now regardless of status, just in case), and the closing stock ticker. Other information such as email messages may be deferred for later sending, which may be just before the user is likely to start interacting with the device or the email application program. Discarding outdated information clearly saves energy, while deferring transmission allows coalescing information, which also saves energy. In general, the proxy 106 is able to defer and coalesce different types of information for sending in a single transmission (e.g., email messages, SMS messages, stock quotes and so forth), whereas a configurable server may be only able to defer and coalesce its own content, such as a user's email messages, for example.

Note that in one alternative implementation, the intermediate proxy 106 may receive data not only from the legacy servers 104, but also from one or more of the configurable information servers 108 (as represented by the dashed line between them in FIG. 1). In this way, more information may be coalesced. Further, information also may be compressed by the intermediate proxy 106. Coalescing information and/or compressing information reduces the amount of transmissions and/or the transmission size, which can reduce the number of communication startups and shutdowns performed at the mobile device, as well as the amount of data transmitted, and can thus reduce energy used, bandwidth consumed, and possibly data plan cost use.

Moreover, certain information delivery applications may be installed on the proxy 106, with the mobile device configured to receive a modified form of the information. By way of example, the proxy 106 may receive updates from various friends in multiple social networks of the user, and then send corresponding combined information to a single update application designed for the mobile device 102.

Turning to the components that are directed towards sensing and determining the user's attention to the device 102, in general these components obtain various state data and/or use the state data to infer a user's likely interest in obtaining information. An attention sensing subsystem 110 represents a module that determines whether the user is currently paying attention to the mobile device, or possibly is likely (e.g., very soon) to be paying attention to the mobile device. The subsystem 110 uses data previously received from the mobile device 102, data from various mobile device sensors 112 connected to or incorporated into the mobile device 102, data received from other devices that the user accesses (block 114), data from the information servers 102 and 106 that may indicate if the user is using information from them, and/or other sensors 116 otherwise present in the user's environment.

The mobile device sensors 112 represent input devices such as a keyboard, pointing device, touch-screen, microphone, camera, buttons or other input mechanism or mechanisms, as well as other device sensors (e.g., accelerometer, gyroscope, GPS and so forth); each of these may be used to determine a user's activities. For example, the various sensors may be processed in combination to detect that the user is driving a vehicle. If driving, the user is not to receive information, for example, so as to save energy and not be disturbed by new information being sent. When the user stops driving and starts interacting with the device, the information may then be pushed from the proxy 106 and/or the servers 108. Note further that the block labeled 112 is not limited to sensors, but also provides other state data about the mobile device 102. For example, the application currently being interacted with by the user may be used to determine whether to download information. As another example, if a user has been notified of new email messages, but has not reviewed those yet (and is currently not using the email program), then there is no reason to send additional email messages until something changes, for example, such as the user interacts with the phone (turns on the device or run a specific application (i.e. the email application in this example).

By way of example of other devices that the user accesses (block 114), user attention also may be sensed via user input at devices other than the mobile device 102, such as other devices connected to the Internet, including a desktop computer, laptop computer, personal digital assistant, televisions/television receivers, manufacturing equipment, automobiles and another mobile device. The user's attention to these other devices may be used to estimate whether the user is likely to be paying attention to the mobile device 102. For example, the user may be known to never use his or her mobile device 102 when operating certain construction equipment that requires full attention. Similarly, if the user is detected as playing a video game on a game console, the user is likely not able to interact with the mobile device 102 at the same time. As another example, a user may not access information via the mobile device 102 when accessing equivalent information on a desktop computer. Note that the specific activity may be used to selectively make a download (or not) or defer download decision; if the user is currently viewing the weather via another device, then do not download weather data to the mobile device, but do download email if appropriate (according to the user's email settings).

By way of example, consider that the attention sensing system gets information from the user's personal computer or an application connected from the user's personal computer to the email server, that the user is actively typing an email on their personal computer. This indicates that the user is unlikely to be reading email on his or her mobile device at the same time. The attention sensing system indicates that, with respect to email information, the user is not paying attention to the mobile device 102. The user interest determination mechanism 120 decides that email is not of interest to the user on the mobile device and indicates to the email server (or the proxy) that new email data need not be sent to the mobile device 102. At the same time, the attention sensing system may also indicate that the user's television and game console are powered off. The user interest determination mechanism 120 knows that the user receives weather alerts via the television (via the game console's Internet connection), and/or via the mobile device 102, and not via the personal computer. The user interest determination mechanism 120 informs the weather server (or the proxy) that any severe weather alerts are to be sent to the mobile device until further notice.

Additionally, other sensors 116, a motion sensor (e.g., of a home security system) and/or camera may detect where a user is in a house, for example, as well as possibly where a user's gaze is directed. Similarly, a user's car GPS may be able to help determine a user's current location outside of a building. Such sensors 116 provide additional information about a user's location and likely current activities. User attention may also be predicted using physiological or biological sensors (such as muscle motion detectors, blood oximeters, electromyogram (EMG), electrocardiograph (ECG), body temperature, pulse rate, breathing rate, and others) that have been determined to be correlated to user's actions with respect to mobile device usage 102. Note that such sensors 116 may be directly coupled to the attention sensing subsystem 110, but may be indirectly connected to it (including any signal and data processing), such as wired or wirelessly through the user's personal computer, gaming console, and so forth, as indicated by the dashed line between blocks 114 and 116 in FIG. 1.

External data 118, such as census/survey data also may be used as a factor to estimate what a person is likely to be doing at a given time of day. For example, some known percentage of people are asleep at 3:00 am; at this time of day, especially if combined with data from sensors 114 and 116 that indicate user inactivity, there is a high likelihood that the user is also sleeping, and energy may be saved by not delivering information to the mobile device 102 at this time. Note however that if the device battery is charging, it may be desirable to send the information while charging, (but not to output an audible notification, for example). More personalized external data 118 may be used, such as to predict user activity from profiles of the groups to which the user is known to belong and may be deemed representative of that user.

The user's attention status may be represented by a single attention indication value for the device 102, such as zero (no attention now or anticipated), a one (anticipated as likely to be paying attention soon), or two (currently paying attention). Alternatively, the attention status may be represented via multiple indication values, such as a value with respect to each different information source (e.g., corresponding to an application). For instance, the user may not be paying attention to email received on the device, but may be actively browsing the stock prices, with an appropriate indication value determined for each corresponding information source.

The user interest determination mechanism 120 receives the indications (value or values) regarding user attention from the attention sensing system 110 and determines which information, if any, should be sent to the mobile device 102. In one implementation, the user interest determination mechanism 120 is rule-based, e.g., according to settings made by the user, however it may be extended in alternative implementations by machine learning or the like to predict user modes. Note that a user may use a slider or the like to choose from among preconfigured sets of default settings as to how aggressive the system is in saving energy versus providing information, and override the individual settings as desired.

Thus, as also represented in FIG. 1, user preference/historical data 122 available to the attention sensing subsystem 110 and/or the user interest determination mechanism 120 may override any default or previously user-configured settings. For example, a user may have configured settings so as to save energy and to not be disturbed, however the user may want to be immediately notified if an email from his boss is received, and may customize the data 122 to configure such a setting. A user's historical usage pattern and so forth may be used to make information download decisions, e.g., a user wakes up at 6:00 am but never checks email messages until 7:30 am, so the attention sensing subsystem 110 and/or the user interest determination mechanism 120 may synchronize the email message downloading so as to complete by 7:30 am.

Moreover, whether based on user preference/historical data 122 and/or built-in overrides, the attention sensing subsystem 110, the user interest determination mechanism 120, a server 108 and/or the proxy 106 can force delivery of information based on other factors. Such factors may include time-of-day, date, size of information, number of pieces of information (e.g., how many email messages) and so forth, which may protect against abnormal situations (such as a sensor giving bad status data). For example, email messages may be downloaded twice a day regardless of user attention status, or such that they are never more than two days old, or when they exceed some size threshold, and/or when there are some threshold number of messages queued for delivery.

In this way, information to be sent to the mobile device is generally selected/timed based on whether the user is likely to pay attention to it, and/or the nature of the information. The configurable information sources 108 are informed whether any data needs to be sent to the mobile device 102. In the case of the legacy information sources 104 that are unable to receive guidance from the user interest determination mechanism 120, the intermediary proxy 106 receives this information. In general, the intermediate proxy 106 continues to receive the information sent by the legacy sources 104, but only selectively sends information to the mobile device 102.

It is possible that the inference is incorrect, such as for unforeseeable reasons. In such a situation, the user will indicate this by reacting in some way, such as explicitly notifying the mobile device 102 of the problem, or implicitly doing something such as shaking the mobile device 102 or the like. The mobile device 102 in turn also reacts to the user behavior and downloads the corresponding information without undue delay.

In sum, the system exemplified in FIG. 1 infers when the user is or will be interested in using a mobile device to access information generated outside of the mobile device 102. The inference may be based upon sensing user attention being paid to the mobile device, as well as the application delivering the required information to the user and/or other state/historical data. The user attention may be sensed using device sensors and other user input devices (including keyboards, touch-screen, mouse and pointing devices and the like) connected to the mobile device. Non-device sensors and other devices, such as motion sensors, temperature sensors, a personal computer, a game console, and so forth may be sources of state data that indicate (alone or in combination) whether a user is paying attention or will be paying attention to the mobile device 102.

Note that FIG. 1 shows only one example of how components may be located and divided. As can be readily appreciated, other configurations are feasible; for example, some or all of the attention sensing subsystem's logic and/or the user interest determination mechanism 120 may be on a cloud service, on the mobile device 102, on a user's personal computer, or some combination thereof.

For example, all or part of the user interest determination module (e.g., another instance or a modified instance) also may be installed on the mobile device 102 to determine when data generated at the mobile device 102 is be uploaded to other entities. In this configuration, the user interest determination module receives the attention statuses of other users, and determines if any other user is likely to pay attention to data sent from the mobile device. For example, the mobile user may type an update for sending via the user's social network. However, the user interest determination module on the mobile device may have previously received a combined status update from the user interest determination module in the Internet that all intended recipients (e.g., all the members) of the user's social network are travelling and are not connected to the mobile phone network until their flight lands at 3:45 pm. In this event, data from the user's device need not to be uploaded to the social network site at this time, and instead can be piggybacked with another communication that takes place before 3:45 pm, thereby saving the energy needed to start up the device transceiver until later.

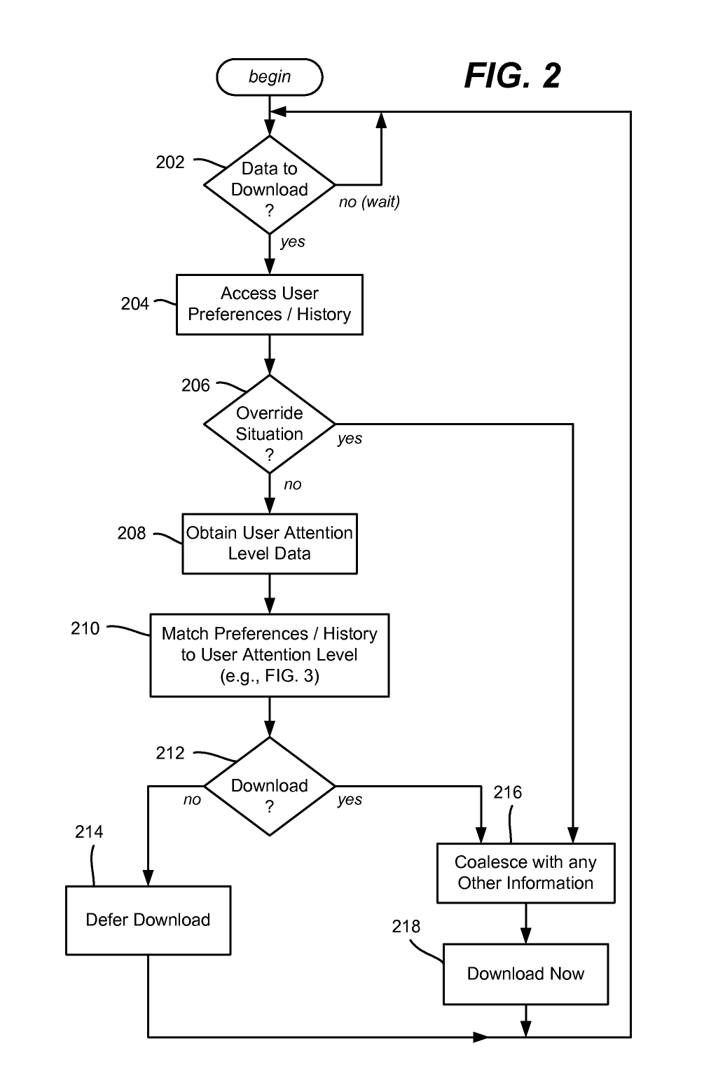

FIG. 2 is a flow diagram showing example steps that may be performed by the attention sensing subsystem 110, user interest determination mechanism 120 and/or proxy 104/server 108. Note that the some or all of the user preference data may be accessed at any level, and the final decision whether to download or defer downloading may be made at any appropriate level or combination of levels.

Step 202 represents waiting until there is information available to download. When there is information, step 204 accesses the user preferences/history data to determine what the user has specified regarding downloading data.

Step 206 represents evaluating the server or proxy information, information to download, data and/or user preferences to determine whether an override situation exists. For example, as described above, a server or the proxy can force the data download attempt regardless of the user or device state, e.g., when an abnormal situation may be present. Also, the information itself may be deemed time-sensitive and important, such as a severe weather update. Further, the user preference data may force a download, e.g., send email when something is received from the boss. If such an override situation exists, step 206 branches to step 216 where the data to download is coalesced with any other data before downloading via step 218. Note that even in a configurable server 108 that only outputs one type of data, new data may be coalesced with older data that has not yet been sent. Note further that coalescing data may include replacing outdated information (e.g., a stock quote or weather update) with more recent information. Multiple-source coalescing may be controlled by the user settings, e.g., only download email messages when interacting with the email program. Compression and other data modification as described above may be performed at this time as well.

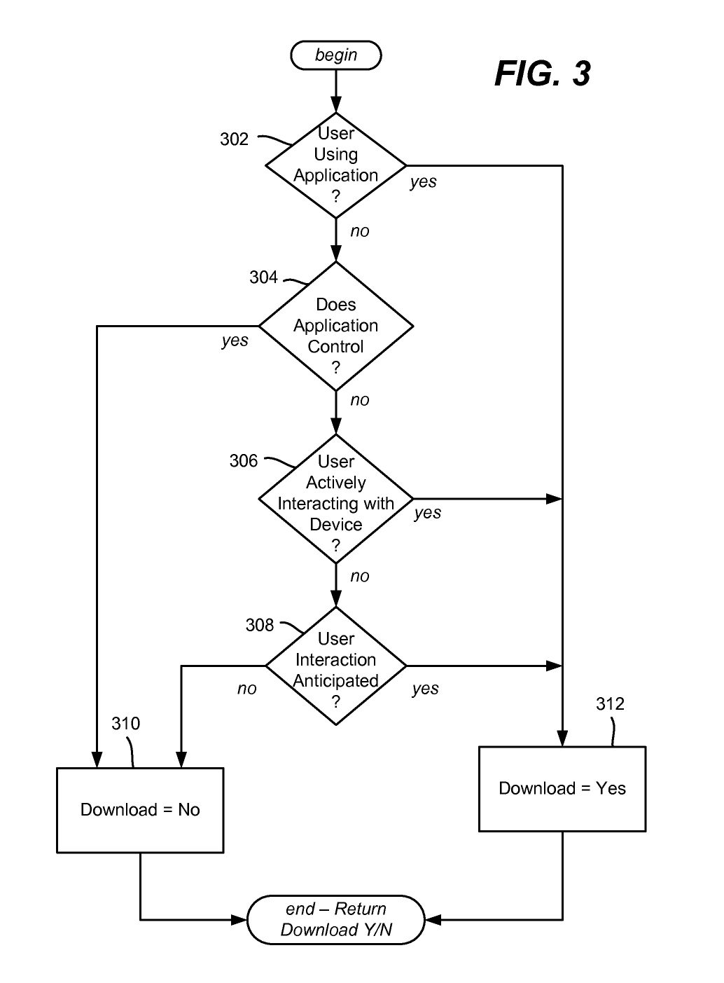

If there is not an override situation, step 206 branches to step 208 where the user's current attention level data is obtained. This is matched to the user preferences/history data at step 210 (an example of such matching is described with reference to FIG. 3) to make a determination on whether to download now or defer downloading.

FIG. 3 shows some possible rule-based examples of whether to download or defer downloading, e.g., corresponding to step 210. Step 302 represents determining whether the user is using an application on the mobile device for which (at least some of) the data is destined. If so, the data is to be downloaded right away (assuming in this example that the user does not have a separate superseding manual/timed download preference).

If the user is not using such an application, step 304 represents determining whether the user has specified that the application usage controls whether to send the data. For example, one user may not want email data sent unless and until the user is interacting with the email program. Another user may not want such a rule. If the user has specified such a rule, then step 304 branches to step 310 where the decision to download is “No” at this time.

Step 306 represents determining whether the user is actively interacting with the device. If so (in this example where the user wants downloading while interacting in any way), then the information is set to be downloaded via step 312.

Step 308 represents determining whether it is anticipated that the user is predicted to be interacting with the device soon. For example, past usage history, current location information of the user location versus device location, current activity information of the user and so forth may be used to predict that the user wants to have the information downloaded now rather than later. If so (in this example where the user has indicated a preference for anticipatory downloading), then the information is set (“Yes”) to be downloaded via step 312.

The yes/no decision made in FIG. 3 may be used at step 212 to determine whether to coalesce/download (steps 216 and 218) now, or defer the download (step 214). As can be readily appreciated, alternative rule handling and other logic may be employed, however even the simplified examples of FIGS. 2 and 3 show how information may be selectively delivered based upon user, device and other state data.

Thus, the computed inference may be based on sensing user attention paid to the mobile device and the application delivering the required information to the user, where the user attention may be sensed using past and current temporal patterns in user's behavior. The inference may be based on sensing user attention using previously specified rules in the user's access patterns, (such as specifying that the user never accesses the mobile device between 1:00 am and 4:00 am). The computed inference may be based on detecting the user's response to past information delivered or summaries of information delivered. For example, if the user has not accessed any email messages after being notified that new email is available, further new email messages may not be delivered until the user accesses the prior emails.

The inference may be based the actions of other users connected to the user's social network or other users that are deemed to be representative of the user. For example, it may be known that the user often accesses the mobile device when the user's friends are known to be sending text messages. User attention may be sensed using sensors such as location sensors connected to the mobile device or other infrastructure. The user's interest in the information may be determined using the importance, severity or nature of information, e.g., email messages from certain senders will trigger or prevent a download, severe weather alerts may be pushed independent of the user's current attention to the device, and so forth. Any of these inferences may be combined, e.g., the time of day, location of the user, location of the user's spouse, the state of the home entertainment system, and severity of weather alerts may be processed to determine if the weather status needs to be sent to the user's mobile device.

As can be seen, information is delivered to the mobile device 102 when it is likely to be of interest to the user and the user is likely to access it via the mobile device (instead of other means). The method is based on sensing user attention to determine if the user is likely to access the information via the mobile device 102.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

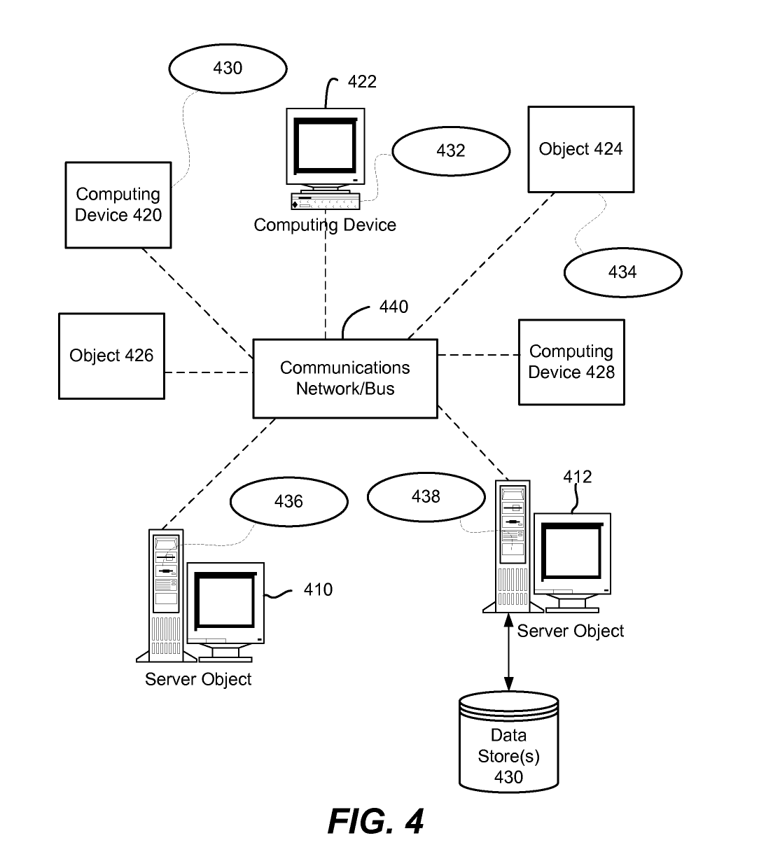

FIG. 4 provides a schematic diagram of an exemplary networked or distributed computing environment. The distributed computing environment comprises computing objects 410, 412, etc., and computing objects or devices 420, 422, 424, 426, 428, etc., which may include programs, methods, data stores, programmable logic, etc. as represented by example applications 430, 432, 434, 436, 438. It can be appreciated that computing objects 410, 412, etc. and computing objects or devices 420, 422, 424, 426, 428, etc. may comprise different devices, such as personal digital assistants (PDAs), audio/video devices, mobile phones, MP3 players, personal computers, laptops, etc.

Each computing object 410, 412, etc. and computing objects or devices 420, 422, 424, 426, 428, etc. can communicate with one or more other computing objects 410, 412, etc. and computing objects or devices 420, 422, 424, 426, 428, etc. by way of the communications network 440, either directly or indirectly. Even though illustrated as a single element in FIG. 4, communications network 440 may comprise other computing objects and computing devices that provide services to the system of FIG. 4, and/or may represent multiple interconnected networks, which are not shown. Each computing object 410, 412, etc. or computing object or device 420, 422, 424, 426, 428, etc. can also contain an application, such as applications 430, 432, 434, 436, 438, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 4, as a non-limiting example, computing objects or devices 420, 422, 424, 426, 428, etc. can be thought of as clients and computing objects 410, 412, etc. can be thought of as servers where computing objects 410, 412, etc., acting as servers provide data services, such as receiving data from client computing objects or devices 420, 422, 424, 426, 428, etc., storing of data, processing of data, transmitting data to client computing objects or devices 420, 422, 424, 426, 428, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 440 or bus is the Internet, for example, the computing objects 410, 412, etc. can be Web servers with which other computing objects or devices 420, 422, 424, 426, 428, etc. communicate via any of a number of known protocols, such as the hypertext transfer protocol (HTTP). Computing objects 410, 412, etc. acting as servers may also serve as clients, e.g., computing objects or devices 420, 422, 424, 426, 428, etc., as may be characteristic of a distributed computing environment.

### Exemplary Computing Device

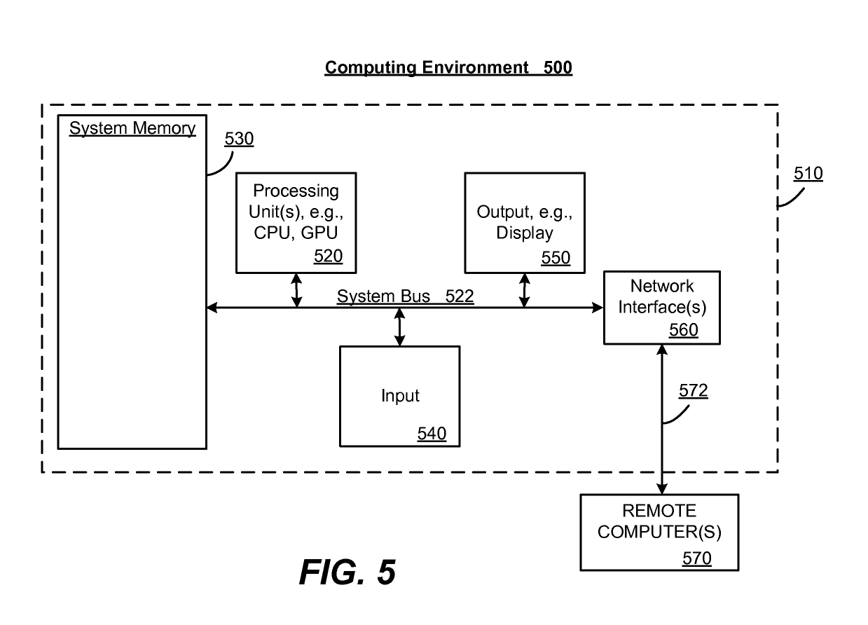

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 5 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 5 thus illustrates an example of a suitable computing system environment 500 in which one or aspects of the embodiments described herein can be implemented, although as made clear above, the computing system environment 500 is only one example of a suitable computing environment and is not intended to suggest any limitation as to scope of use or functionality. In addition, the computing system environment 500 is not intended to be interpreted as having any dependency relating to any one or combination of components illustrated in the exemplary computing system environment 500.

With reference to FIG. 5, an exemplary remote device for implementing one or more embodiments includes a general purpose computing device in the form of a computer 510. Components of computer 510 may include, but are not limited to, a processing unit 520, a system memory 530, and a system bus 522 that couples various system components including the system memory to the processing unit 520.

Computer 510 typically includes a variety of computer readable media and can be any available media that can be accessed by computer 510. The system memory 530 may include computer storage media in the form of volatile and/or nonvolatile memory such as read only memory (ROM) and/or random access memory (RAM). By way of example, and not limitation, system memory 530 may also include an operating system, application programs, other program modules, and program data.

A user can enter commands and information into the computer 510 through input devices 540. A monitor or other type of display device is also connected to the system bus 522 via an interface, such as output interface 550. In addition to a monitor, computers can also include other peripheral output devices such as speakers and a printer, which may be connected through output interface 550.

The computer 510 may operate in a networked or distributed environment using logical connections to one or more other remote computers, such as remote computer 570. The remote computer 570 may be a personal computer, a server, a router, a network PC, a peer device or other common network node, or any other remote media consumption or transmission device, and may include any or all of the elements described above relative to the computer 510. The logical connections depicted in FIG. 5 include a network 572, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
obtaining state data with respect to a current state of a user, or a current state of a mobile device, or both a current state of a user and a current state of a mobile device;
processing the state data to compute an inference as to when the user is likely to be interested in accessing what kind of information available for downloading to the mobile device; and
downloading corresponding information based upon the inference.

2. The method of claim 1 wherein the inference indicates that the user is not likely to be interested in accessing the information until later, and wherein downloading the information based upon the inference comprises deferring delivery of the information.

3. The method of claim 1 wherein the inference indicates that the user is likely to be interested in currently accessing the information, and wherein downloading the information based upon the inference comprises communicating to attempt delivery of the information without undue delay.

4. The method of claim 1 wherein obtaining the state data comprises determining that the mobile device is currently running an application program.

5. The method of claim 1 wherein obtaining the state data comprises sensing state data corresponding to user attention paid to the mobile device, including sensing input device usage of a keyboard, touch-screen, pointing device, button, microphone, camera or other input mechanism coupled to or incorporated into the mobile device, or any combination of a keyboard, touch-screen, pointing device, button, microphone, camera or other input mechanism coupled to or incorporated into the mobile device.

6. The method of claim 1 wherein obtaining the state data comprises sensing state data corresponding to user attention paid to the mobile device, including sensing via physiological or biological sensors, or both physiological and biological sensors.

7. The method of claim 1 wherein obtaining the state data comprises sensing state data of one or more location sensors corresponding to user location or mobile device location, or both user location and mobile device location.

8. The method of claim 1 wherein obtaining the state data comprises sensing state data corresponding to user attention paid to one or more other devices other than the mobile device, including a desktop computer, laptop computer, personal digital assistant, television, television receiver, appliance, equipment, machinery, vehicle, or other mobile device, or any combination of the one or more other devices.

9. The method of claim 1 wherein processing the state data to compute the inference includes processing past and current temporal patterns in user behavior, or detecting user response to information previously delivered or summaries of information previously delivered or both, or any combination of processing past and current temporal patterns in user behavior or detecting user response to information previously delivered or summaries of information previously delivered, or both.

10. The method of claim 1 further comprising, reacting to user behavior indicating that the inference is incorrect by downloading the corresponding information without undue delay.

11. The method of claim 1 wherein processing the state data to compute the inference includes using one or more actions of others that connect to the mobile device via a social network, or one or more actions of others deemed to be representative of the mobile device's user, or both one or more actions of others that connect to the mobile device via a social network and one or more actions of others deemed to be representative of the mobile device's user.

12. The method of claim 1 wherein user's interest in the information is determined using the nature of the information, including the information's sender or the information's likely importance to the user, or both the information's sender and the information's likely importance to the user.

13. The method of claim 1 wherein downloading the information comprises receiving the information at an intermediate proxy, and sending the information from the intermediate proxy to the mobile device based upon the inference.

14. The method of claim 1 further comprising, compressing at least some of the information into compressed data, or modifying at least some of the data into modified information, or both compressing at least some of the information into compressed data and modifying at least some of the data into modified information, and wherein downloading the information comprises downloading the compressed data or the modified data, or both the compressed data and the modified data.

15. The method of claim 1 further comprising, coalescing information from a plurality of different sources into coalesced information, or coalescing deferred information with current information into coalesced information, or both coalescing information from a plurality of different sources and coalescing deferred information with current information into coalesced information, and wherein downloading the information comprises downloading the coalesced information.

16. In a computing environment, a system comprising:
an information source configured to deliver information to a mobile device;
an attention sensing subsystem configured to determine an attention level indicative of a user's attention with respect to a mobile device, including by receiving state data; and
a user interest determination mechanism coupled to the attention sensing subsystem, the user interest determination mechanism configured to communicate with the information source to determine based on the attention level when to download information to the mobile device.

17. The system of claim 16 wherein the information source comprises a proxy that receives the information from one or more information servers.

18. The system of claim 17 wherein the proxy is configured as a virtual machine that emulates the mobile device from the perspective of the one or more information servers.

19. One or more computer-readable media having computer-executable instructions, which when executed perform steps, comprising:
receiving attention level data indicative of an attention level with respect to a user's interaction or anticipated interaction with a mobile device;
matching preference data, or history data, or both preference data and history data with the attention level data to compute an inferred decision as to whether to download available information to the mobile device without delay or whether to defer downloading the available information to the mobile device; and
downloading the information without delay or deferring the download based upon the decision.

20. The one or more computer-readable media of claim 19 wherein the decision corresponds to downloading the information without delay, and having further computer-executable instructions comprising, coalescing the information with other information that was deferred into coalesced information, and wherein downloading the information without delay comprises downloading the coalesced information.
